(19) United States
(12) Patent Application Publication
(10) Pub. No.: US 2011/0036274 A1
(43) Pub. Date: Feb. 17, 2011

(54) Table and Room Configuration

(76) Inventors: Michael Poost, West Sand Lake, NY (US); Alejandro A. Stivala, Niskayuna, NY (US); John Adams, Saratoga Springs, NY (US)

Correspondence Address: HOFFMAN WARNICK LLC, 75 STATE STREET, 14TH FLOOR, ALBANY, NY, 12207, US

(21) Appl. No.: 12/813,796

(22) Filed: Jun. 11, 2010

Related U.S. Application Data
(60) Provisional application No. 61/233,006, filed on Aug. 11, 2009.

(51) Int. Cl. A47B 13/00; A47B 3/00; B23P 11/00; A47B 41/00

(52) U.S. Cl. 108/42; 29/428; 434/432

(57) ABSTRACT

Desk units that can be reconfigured to support, for example, collaboration between two or more individuals are provided. A first desk unit can include an operable modesty panel, which can be substantially perpendicular to the floor in one configuration, and can be relocated to be substantially parallel to the floor and in line with a table panel to provide an enlarged work area in a second configuration. The enlarged work area can be used by two or more individuals for collaboration. In addition, a second desk unit including an operable table panel, which can be substantially parallel to the floor in one configuration, and can be relocated to be substantially perpendicular to the floor in a second configuration can be located in front of the first desk unit. The operable table panel can be lowered to provide additional room for an individual to turn around and collaborate with another individual using the enlarged work area of the first desk unit.

### REFERENCE TO PRIOR APPLICATION

The current application claims the benefit of co-pending U.S. Provisional Application No. 61/233,006, titled “Table and Room Configuration”, which was filed on 11 Aug. 2009, and which is hereby incorporated by reference.

### TECHNICAL FIELD

The disclosure relates generally to furniture, and more particularly, to a table and room configuration.

### BACKGROUND ART

Rooms configured to hold multiple individuals, each of whom may desire a surface for writing, holding a laptop, and/or the like, often include multiple tables. Each table can be fixed to the floor, and seating can be incorporated with the table or be separately provided using a chair. Typically, each table includes a fixed surface for use by one or more individuals. All tables and chairs are typically arranged so that all of the individuals will face a single direction, e.g., in rows facing a teacher, or towards a central area, e.g., towards a central display. Reconfiguration of the tables is relatively complex and time consuming.

In some classrooms, tables that are not fixed to the floor are used. This enables the tables to be moved and rearranged to facilitate different types of interaction. For example, in a classroom environment, a professor may desire to both lecture and facilitate collaboration between students. In this case, the tables can be moved to facilitate either method of teaching.

### SUMMARY OF THE INVENTION

Aspects of the invention provide desk units that can be reconfigured to support, for example, collaboration between two or more individuals. A first desk unit can include an operable modesty panel, which can be substantially perpendicular to the floor in one configuration, and can be relocated to be substantially parallel to the floor and in line with a table panel to provide an enlarged work area in a second configuration. The enlarged work area can be used by two or more individuals for collaboration. In addition, a second desk unit including an operable table panel, which can be substantially parallel to the floor in one configuration, and can be relocated to be substantially perpendicular to the floor in a second configuration can be located in front of the first desk unit. The operable table panel can be lowered to provide additional room for an individual to turn around and collaborate with another individual using the enlarged work area of the first desk unit.

A first aspect of the invention provides a room comprising: a first desk unit comprising: a set of elongate support members; and an operable table panel supported by the set of elongate support members, wherein the operable table panel is configured to be fixed in a first position approximately perpendicular to the set of elongate support members or located in a second position approximately parallel to the set of elongate support members; and a second desk unit comprising: a set of elongate support members; a table panel supported by the set of elongate support members; and an operable modesty panel supported by the set of elongate support members, wherein the operable modesty panel is configured to be fixed in a first position approximately perpendicular to the set of elongate support members or located in a second position approximately parallel to the set of elongate support members, wherein the first desk unit and the second desk unit are located such that an individual between the first desk unit and the second desk unit can use either the operable table panel or the operable modesty panel as a work area.

A second aspect of the invention provides a room comprising: a first row of a plurality of desk units facing a first direction; and a second row of a plurality of desk units facing the first direction, wherein a desk unit in the second row includes an operable modesty panel, wherein the operable modesty panel is configured to be fixed in a first position approximately parallel to a floor of the room or located in a second position approximately perpendicular to the floor of the room, wherein the desk unit in the second row and a desk unit in the first row are located such that an individual between the desk unit in the first row and the desk unit in the second row can use the operable modesty panel as a work area when it is fixed in the first position.

A third aspect of the invention provides a method comprising: installing a plurality of desk units in a classroom, the installing including: installing a first desk unit at a first location, the first desk unit comprising an operable modesty panel configured to be relocated between a first position substantially perpendicular to a floor of the classroom and a second position substantially parallel to the floor of the classroom; and installing a second desk unit at a second location in front of the first desk unit, wherein an individual located at the second desk unit can use a table panel of the second desk unit as a work area when facing toward the front of the classroom and can use the operable modesty panel located in the second position as a work area when facing toward the rear of the classroom.

A fourth aspect of the invention provides a method comprising: configuring a classroom for collaboration between a plurality of students, the configuring including: relocating a modesty panel of a first desk unit from a first position substantially perpendicular to a floor of the classroom to a second position substantially parallel to the floor of the classroom, wherein the modesty panel and a table panel of the first desk unit provide a collaborative work area for at least two of the plurality of students.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIGS. 1A, 1B show an isometric view of an illustrative pair of desk units in first and second configurations, respectively, according to an embodiment.

FIGS. 2A, 2B show a top plan view of the illustrative pair of desk units in the first and second configurations, respectively, according to an embodiment.

FIGS. 3A, 3B show a side view of the illustrative pair of desk units in the first and second configurations, respectively, according to an embodiment.

FIGS. 4A, 4B show a side view of another illustrative desk unit in a first and a second configuration, respectively, according to an embodiment.

FIGS. 5A, 5B show a top plan view of an illustrative room in first and second configurations, respectively, according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide desk units that can be reconfigured to support, for example, collaboration between two or more individuals. A first desk unit can include an operable modesty panel, which can be substantially perpendicular to the floor in one configuration, and can be relocated to be substantially parallel to the floor and in line with a table panel to provide an enlarged work area in a second configuration. The enlarged work area can be used by two or more individuals for collaboration. In addition, a second desk unit including an operable table panel, which can be substantially parallel to the floor in one configuration, and can be relocated to be substantially perpendicular to the floor in a second configuration can be located in front of the first desk unit. The operable table panel can be lowered to provide additional room for an individual to turn around and collaborate with another individual using the enlarged work area of the first desk unit. As used herein, unless otherwise noted, the term “set” means one or more (i.e., at least one) and the phrase “any solution” means any now known or later developed solution.

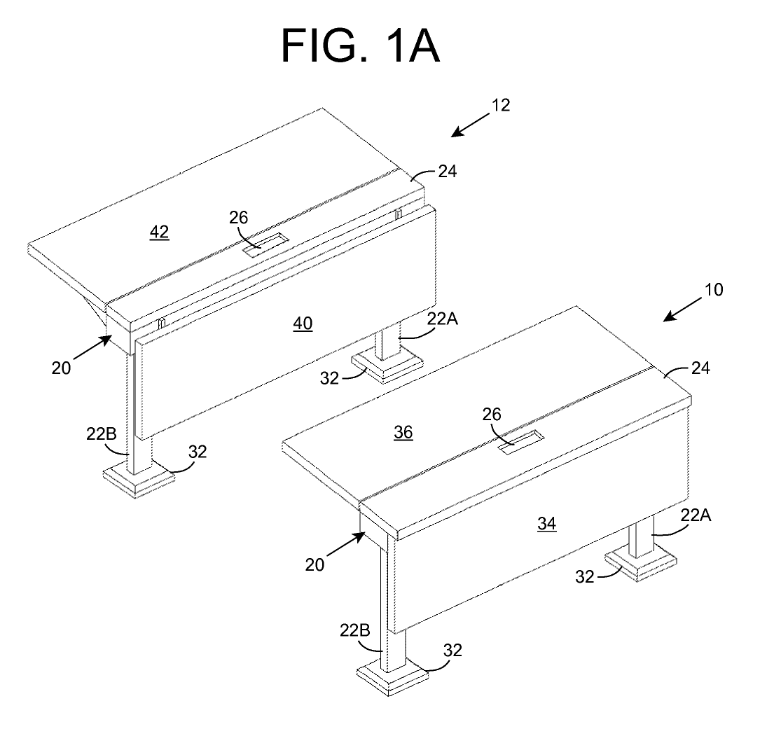

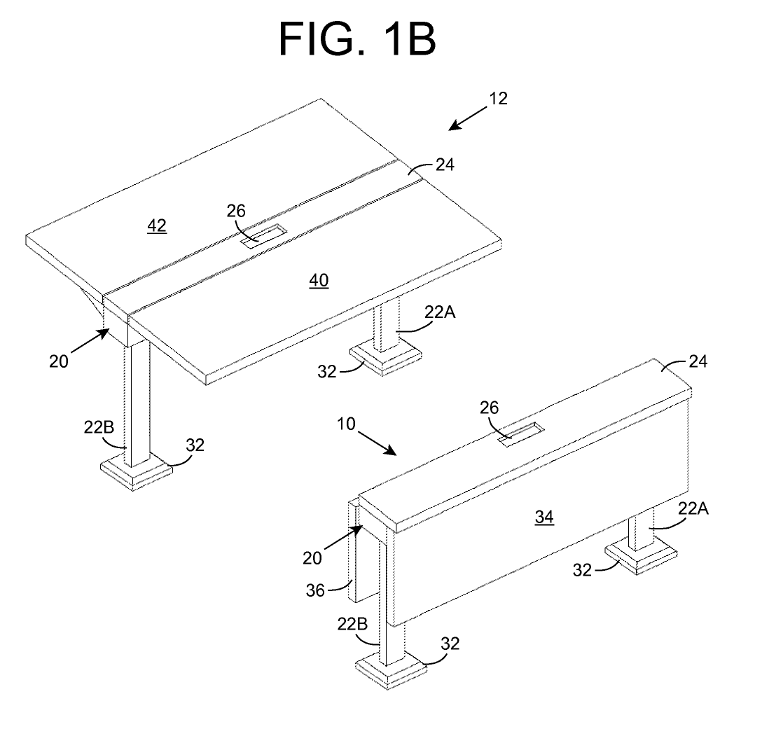

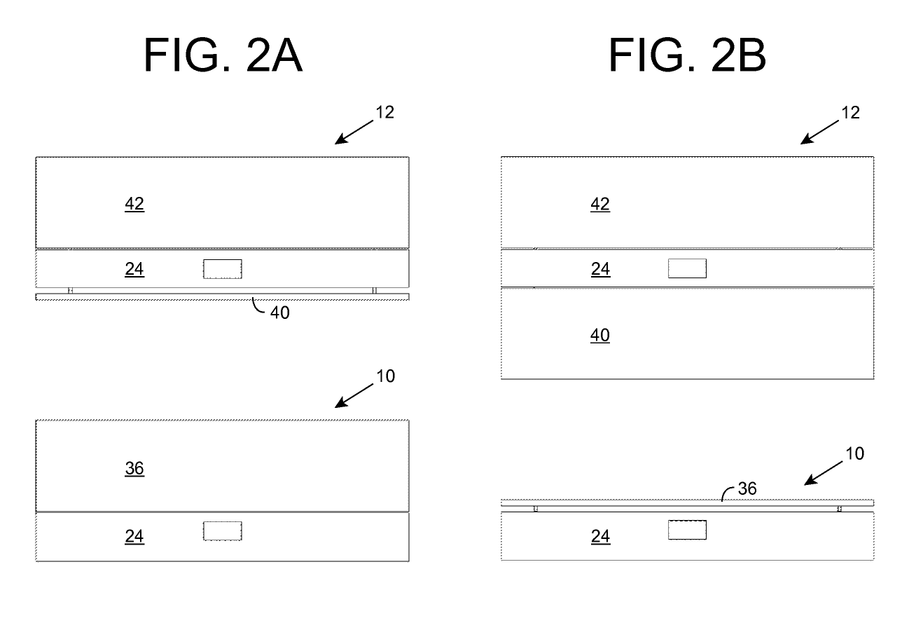

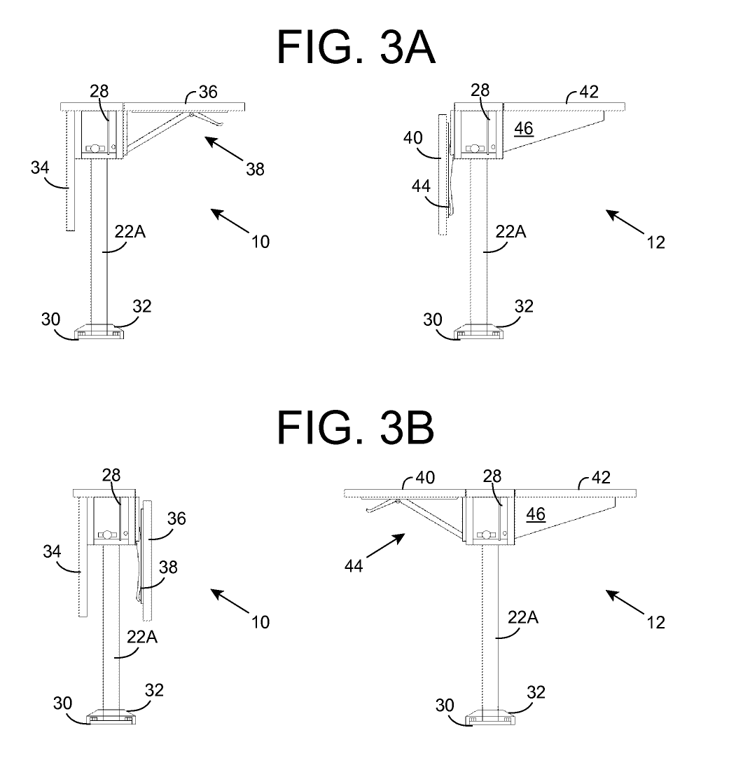

Turning to the drawings, FIGS. 1A, 1B show an isometric view of an illustrative pair of desk units 10, 12 in first and second configurations, respectively, according to an embodiment. Similarly, FIGS. 2A, 2B show a top plan view of the illustrative pair of desk units 10, 12 in the first and second configurations, respectively, according to an embodiment, and FIGS. 3A, 3B show a side view of the illustrative pair of desk units 10, 12 in the first and second configurations, respectively, according to an embodiment.

With reference to these figures collectively, each desk unit 10, 12 includes a core 20, supports 22A, 22B, a central panel 24, and a set of wiring terminals access area 26. As illustrated in the side views of desk units 10, 12 in FIGS. 3A, 3B, core 20 and central panel 24 can together form a rigid box with a hollow interior. The interior space formed by core 20 and central panel 24 can be used to facilitate electrical and/or data wiring to/from the set of wiring terminals access area 26. In an embodiment, the interior space is subdivided into two sub-regions along its length by a core septum 28. In this case, one of the sub-regions can be utilized for data wiring, while another of the sub-regions can be utilized for electrical wiring (e.g., an electrical wiring harness).

Central panel 24 can be attached to core 20 using any solution that facilitates access to the interior space. For example, central panel 24 can be attached to core 20 using a set of hinges, which enable a side of central panel 24 to be lifted. Alternatively, central panel 24 can be removably secured to central panel 24, e.g., by a set (e.g., four) of cleats. The core septum 28 can comprise any type of material, such as hardboard, a plastic (e.g., a polycarbonate resin thermoplastic), a metal (e.g., tin, aluminum, and/or the like), etc. The core septum 28 can be located within the core 20 using any combination of one or more solutions, such as insertion into a set of grooves/slots formed in the bottom of the core 20, glue, brads, and/or the like. Each support 22A, 22B also can be attached to core 20 using any combination of one or more attachment solutions. In an embodiment, each support 22A, 22B includes a welded nut, and a bolt is screwed through a bottom surface of core 20 and the welded nut of the support 22A, 22B.

Each support 22A, 22B also can be attached to a floor to prevent movement of the desk units 10, 12 using any combination of one or more of various attachment solutions. For example, in an embodiment, a bottom of each support 22A, 22B can comprise a flange 30 having a set (e.g., four) of screw holes, through which a corresponding anchor bolt is screwed into the floor. Additionally, a base cover 32 can be included, which is configured to removably cover the bottom of a support 22A, 22B (and any attachment mechanism) using any solution, e.g., by being slid up and down the support 22A, 22B. The base cover 32 can be manufactured using any material, such as injection molded plastic.

Desk unit 10 further includes a fixed modesty panel 34 and an operable table panel 36. Fixed modesty panel 34 can be secured to, for example, a side surface of the core 20 using any attachment solution, such as any combination of one or more various attachment solutions, such as screws, nails, glue, and/or the like. Operable table panel 36 is shown attached to desk unit 10 using a set of operable hinge brackets 38. Each operable hinge bracket 38 can be secured to, for example, a side surface of the core 20 and a bottom of the operable table panel 36 using any combination of one or more of various attachment solutions, such as screws, thru screws, and/or the like.

Operable table panel 36 can be selectively located in either of a pair of positions using the set of operable hinge brackets 38. In particular, in a first configuration shown in FIGS. 1A, 2A, and 3A, the operable table panel 36 can be located in a first position that is approximately perpendicular to the supports 22A, 22B of the desk unit 10 using the set of operable hinge brackets 38. In the first configuration, the operable table panel 36 and the central panel 24 can collectively provide a work surface of a desired size for one or more individuals using desk unit 10. In a second configuration shown in FIGS. 1B, 2B, and 3B, the operable table panel 36 can be located in a second position that is approximately parallel to the supports 22A, 22B of the desk unit 10 using the set of operable hinge brackets 38. In the second configuration, the desk unit 10 will comprise a relatively narrow work surface provided only by the central panel 24.

Desk unit 12 further includes an operable modesty panel 40 and a fixed table panel 42. Operable modesty panel 40 is shown attached to desk unit 12 using a set of operable hinge brackets 44. Each operable hinge bracket 44 can be secured to, for example, a side surface of the core 20 and a bottom of operable modesty panel 40 using any combination of one or more of various attachment solutions, such as screws, thru screws, and/or the like. Fixed table panel 42 can be secured to, for example, a side of the core 20 using any attachment solution, such as a set of fixed support brackets 46, each of which can be secured to a side surface of the core 20 and a bottom of the fixed table panel 46 using any combination of one or more of various attachment solutions, such as screws, thru screws, and/or the like.

Operable modesty panel 40 can be selectively located in either of a pair of positions using the set of operable hinge brackets 44. In particular, in a first configuration shown in FIGS. 1A, 2A, and 3A, the operable modesty panel 40 can be located in a first position that is approximately parallel to the supports 22A, 22B of the desk unit 10 using the set of operable hinge brackets 44. In the first configuration, the fixed table panel 42 and the central panel 24 can collectively provide a work surface of a desired size for one or more individuals using desk unit 12. In a second configuration shown in FIGS. 1B, 2B, and 3B, the operable modesty panel 40 can be located in a second position that is approximately perpendicular to the supports 22A, 22B of the desk unit 12 using the set of operable hinge brackets 44. In the second configuration, the fixed table panel 42, the central panel 24, and the operable modesty panel 40 can collectively provide an enlarged work surface of a desired size for one or more individuals using desk unit 12.

Each desk unit 10, 12 can be manufactured using any solution. In an embodiment, the core 20 comprises a rigid U-shaped elongate member comprising a substrate of medium density fiber (MDF) board with an external material of high pressure plastic laminate (HPL). Each panel 34, 36, 40, 42 can be formed of any type of material, such as a laminate having a PVC edge, or the like. Additionally, each support 22A, 22B can be manufactured of any material, e.g., a hollow elongate metal member.

As discussed herein, the side surfaces of the core 20 can provide a supportive surface for a fixed modesty panel 34, each operable hinge bracket 38, 44, each fixed support bracket 46, and a bottom surface of the core 20 can provide a mounting surface for the supports 22A, 22B. In an embodiment, the core 20 provides support for a static load of at least six hundred pounds. Regardless, it is understood that the various mounting solutions shown and described herein are only illustrative. To this extent, the various components can be connected to the core 20 and/or one or more other components using any solution. For example, one or more components of each desk unit 10, 12, such as a bracket 38, 44, 46, can be mounted to a support 22A, 22B, or the like in addition to or as an alternative to mounting to the core 20.

Each desk unit 10, 12 can comprise any desired dimensions for the various configurations. For example, a work surface of each desk unit 10, 12 can be located approximately 29.5 inches from the floor. The work surface of each desk unit 10, 12 can comprise a width of approximately five feet. In the first configuration, each desk unit 10, 12 can provide a work surface of a depth of approximately two feet. In a more particular embodiment, desk unit 10 comprises a depth of approximately 22⅞ inches, while desk unit 12 comprises a depth of approximately 21⅛ inches. In this case, the central panel 24 of desk unit 10 can comprise a larger depth (e.g., approximately 1¾ inches larger) than the central panel 24 of the desk unit 12 to cover the edge of the fixed modesty panel 34. In the second configuration, the desk unit 10 can comprise a work surface having a depth of approximately 7¾ inches (e.g., the depth of the central panel 24) with a total width of approximately ten inches, and the desk unit 12 can comprise a work surface having a depth of approximately three feet.

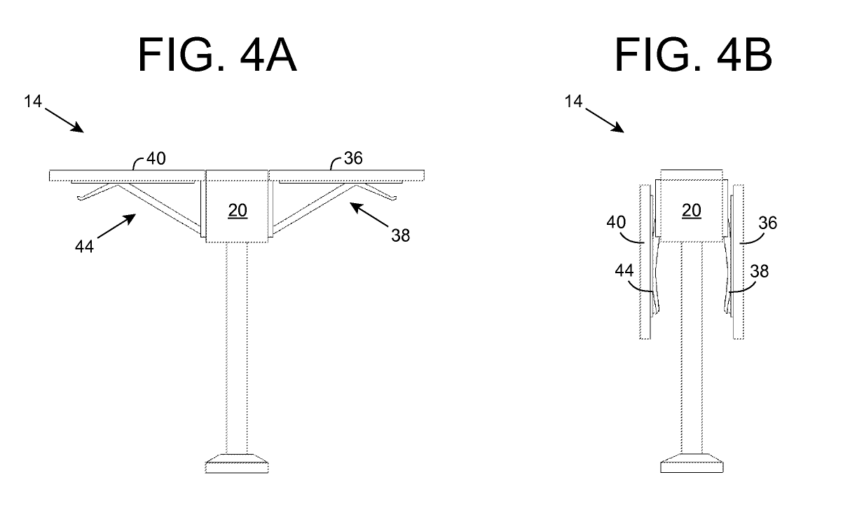

It is understood that desk units 10, 12 are only illustrative, and that various alternative embodiments are possible. For example, FIGS. 4A and 4B show another illustrative desk unit 14 in a first and a second configuration, respectively, according to an embodiment. Desk unit 14 includes both an operable table panel 36 and an operable modesty panel 40, each of which is attached to the core 20 using an operable hinge bracket 38, 44, respectively. The remaining components of desk unit 14, including core 20, can be implemented similar to desk units 10, 12 discussed herein. In this configuration, desk unit 14 can be placed into four different operable configurations. In particular, desk unit 14 can be configured such that: both operable panels 36, 40 are raised (as shown in FIG. 4A); both operable panels 36, 40 are lowered (as shown in FIG. 4B); operable table panel 36 is raised while operable modesty panel 40 is lowered; and operable table panel 36 is lowered while operable modesty panel 40 is raised.

It is understood that the various dimensions shown and described herein are only illustrative and numerous alternatives are possible. Additionally, it is understood that a desk unit may not include all of the features shown and described herein including, but not limited to, electrical wiring, base cover(s), wiring terminals access areas, and/or the like. Similarly, it is understood that a desk unit may include one or more additional features, such as two or more wiring terminals access areas, three or more supports, a cover for an outer end of the core 20, and/or the like.

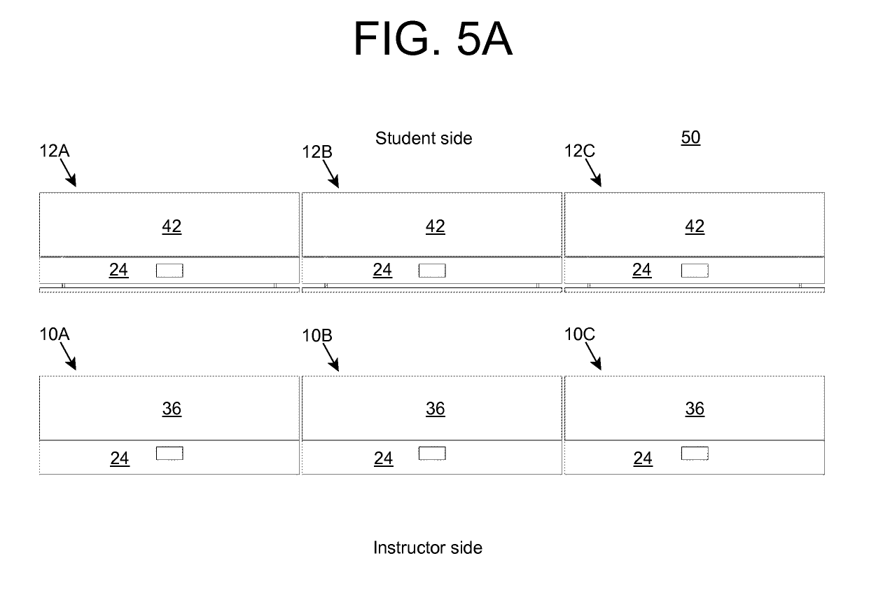

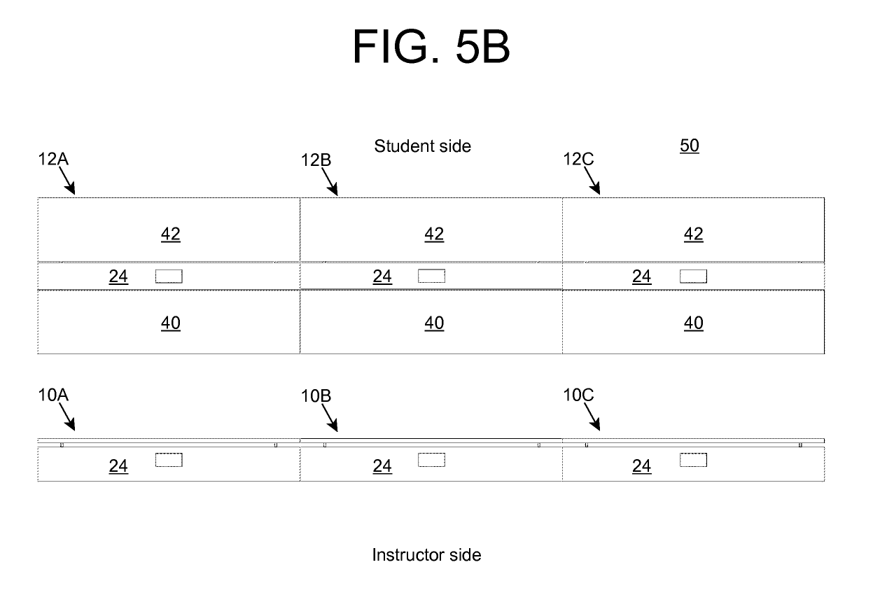

In an embodiment, multiple desk units are installed in a room, such as a classroom, and are configured to be used in conjunction with one another. To this extent, FIGS. 5A and 5B show a top plan view of an illustrative room 50 in first and second configurations, respectively, according to an embodiment. As illustrated, the room 50 can include a first row of desk units 10A-10C, each of which comprises an operable table panel 36, located in front of a second row of desk units 12A-12C, each of which comprises an operable modesty panel 40. In the first configuration, an individual located on the “student side” of one of the desk units 10A-10C, 12A-12C will have a working surface (e.g., the corresponding table panel 36 or 42 and central panels 24) in front of him/her as he/she faces the “instructor side” of the room. In the second configuration, an individual on the student side of a desk unit 10A-10C in the first row can turn around and face the student side of the room and utilize the working surface of the corresponding desk unit 12A-12C in the second row, which includes the operable modesty panel 40 in addition to the table panel 42 and central panel 24 of the desk unit 12A-12C. To this extent, the individual can work in collaboration with an individual located on the student side of a desk unit 12A-12C in the second row. In this manner, desk units 10A-10C, 12A-12C can be used to accommodate both traditional lecture in a classroom as well as collaboration/conferencing among individuals in adjacent rows. As shown in FIGS. 3A, 3B, an individual located between desk units 10, 12, can operate both operable hinge brackets 38, 44 to change each desk unit 10, 12 from the first configuration to the second configuration.

As shown in FIGS. 5A, 5B, desk units 10A-10C, 12A-12C can be installed in a room 50, such as a classroom, so that they are approximately perpendicular to a side of the room 50 corresponding to a location of an instructor or other speaker. However, it is understood that the desk units 10A-10C, 12A-12C can be arranged to be substantially perpendicular to one or more of any type of focal area(s), such as a central part of the room 50, a central area of a set of desk units, or the like. Additionally, it is understood that each row of desk units can include any number of desk units and a room 50 can include any number of rows of desk units. In an embodiment, a room 50 can include alternating rows of desk units 10A-10C, 12A-12C. To this extent, the first, third, fifth, etc. rows of desk units can be formed using a set of desk units 10, while the second, fourth, sixth, etc. rows of desk units can be formed using a set of desk units 12. In still another embodiment, one or more rows of desk units can be formed using alternative desk units, such as desk unit 14 (FIGS. 4A, 4B). For example, in a room 50 having three or more rows of desk units, the first row can comprise desk units 10, the last row can comprise desk units 12, and each interior row can comprise desk units 14. Regardless, it is understood that a room 50 and/or a row also can comprise one or more desk units that do not include an operable panel.

While shown and described herein as a table and room configuration, it is understood that aspects of the invention further provide various alternative embodiments. For example, in one embodiment, the invention provides a method of configuring a classroom with a plurality of tables. In particular the plurality of tables can enable the classroom to be configured to support both lecture and student collaboration without requiring the physical rearranging of tables in the classroom. The method can include installing a plurality of tables in the classroom such that pairs of tables can be reconfigured to enable collaboration between two or more students located at each pair of tables. To this extent, a first table can be installed in front of another table, which includes an operable modesty panel as shown and described herein. Furthermore, the first table can include an operable table panel as shown and described herein. The configuring the room can include one or more additional actions, such as the installation of seating for individuals utilizing the classroom, the installation of electrical and/or data wiring, which can include installing electrical and/or data terminals in one or more of the tables, and/or the like.

In another embodiment, aspects of the invention provide a method of utilizing the classroom, which includes reconfiguring the classroom between alternative configuration that make the classroom conducive for collaboration or lecture. In this case, the method can include relocating an operable modesty panel of a first desk unit from a lowered position substantially perpendicular to the floor to a raised position substantially parallel to the floor. The method can also include relocating a table panel of a second desk unit located in front of the first desk unit from a raised position substantially parallel to the floor to a lowered position substantially perpendicular to the floor.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A room comprising:
a first desk unit comprising:
a set of elongate support members; and
an operable table panel supported by the set of elongate support members, wherein the operable table panel is configured to be fixed in a first position approximately perpendicular to the set of elongate support members or located in a second position approximately parallel to the set of elongate support members; and
a second desk unit comprising:
a set of elongate support members;
a table panel supported by the set of elongate support members; and
an operable modesty panel supported by the set of elongate support members, wherein the operable modesty panel is configured to be fixed in a first position approximately perpendicular to the set of elongate support members or located in a second position approximately parallel to the set of elongate support members, wherein the first desk unit and the second desk unit are located such that an individual between the first desk unit and the second desk unit can use either the operable table panel or the operable modesty panel as a work area.

2. The room of claim 1, wherein each of the first desk unit and the second desk unit includes:
a core comprising a bottom, a first side, and a second side; and
a central panel attached to a top of the core, wherein the core and the central panel form an elongate box with a hollow interior, and wherein each elongate support member is attached to the bottom of the core.

3. The room of claim 1, wherein each of the first desk unit and the second desk unit is attached to a floor of the room.

4. The room of claim 1, wherein the first desk unit further comprises a fixed modesty panel supported by the set of elongate support members.

5. The room of claim 1, wherein the table panel of the second desk unit is fixed in a position approximately perpendicular to the set of elongate support members.

6. A room comprising:
a first row of a plurality of desk units facing a first direction; and
a second row of a plurality of desk units facing the first direction, wherein a desk unit in the second row includes an operable modesty panel, wherein the operable modesty panel is configured to be fixed in a first position approximately parallel to a floor of the room or located in a second position approximately perpendicular to the floor of the room, wherein the desk unit in the second row and a desk unit in the first row are located such that an individual between the desk unit in the first row and the desk unit in the second row can use the operable modesty panel as a work area when it is fixed in the first position.

7. The room of claim 6, wherein the desk unit in the first row includes an operable table panel configured to be fixed in a first position approximately parallel to the floor of the room or located in a second position approximately perpendicular to the floor of the room.

8. The room of claim 7, wherein each desk unit in the first row includes the operable table panel.

9. The room of claim 6, wherein each desk unit in the second row includes the operable modesty panel.

10. The room of claim 6, wherein each desk unit in the first and second rows is attached to the floor of the room.

11. The room of claim 6, wherein each desk unit in the first and second rows includes:
a set of elongate support members;
a core comprising a bottom, a first side, and a second side, wherein each elongate support member is attached to the bottom of the core; and
a central panel attached to a top of the core, wherein the core and the central panel form an elongate box with a hollow interior.

12. The room of claim 6, wherein the desk unit in the second row further includes an operable table panel configured to be fixed in a first position approximately parallel to the floor of the room or located in a second position approximately perpendicular to the floor of the room.

13. A method comprising:
installing a plurality of desk units in a classroom, the installing including:
installing a first desk unit at a first location, the first desk unit comprising an operable modesty panel configured to be relocated between a first position substantially perpendicular to a floor of the classroom and a second position substantially parallel to the floor of the classroom; and
installing a second desk unit at a second location in front of the first desk unit, wherein an individual located at the second desk unit can use a table panel of the second desk unit as a work area when facing toward the front of the classroom and can use the operable modesty panel located in the second position as a work area when facing toward the rear of the classroom.

14. The method of claim 13, wherein the second desk unit includes an operable table panel configured to be relocated between a first position substantially parallel to the floor of the classroom and a second position substantially perpendicular to the floor of the classroom.

15. The method of claim 13, wherein the installing the plurality of desk units includes:
installing a first row of desk units, each desk unit in the first row comprising the operable modesty panel, wherein the installing the first desk unit is performed as part of installing the first row; and
installing a second row of desk units in front of the first row of desk units, wherein the installing the second desk unit is performed as part of installing the second row.

16. The method of claim 15, further comprising installing electrical wiring in each desk unit in the first and second rows of desk units.

17. The method of claim 15, further comprising installing seating for at least one individual at each of the plurality of desk units.

18. A method comprising:
configuring a classroom for collaboration between a plurality of students, the configuring including:
relocating a modesty panel of a first desk unit from a first position substantially perpendicular to a floor of the classroom to a second position substantially parallel to the floor of the classroom, wherein the modesty panel and a table panel of the first desk unit provide a collaborative work area for at least two of the plurality of students.

19. The method of claim 18, the configuring further including relocating a table panel of a second desk unit from a first position substantially parallel to the floor of the classroom to a second position substantially perpendicular to the floor of the classroom, wherein the second desk unit is positioned in front of and substantially parallel to the modesty panel of the first desk unit.

20. The method of claim 18, further comprising reconfiguring the classroom for lecture, wherein the reconfiguring includes relocating the modesty panel of the first desk from the second position to the first position.
